(19) United States
(12) Patent Application Publication
(10) Pub. No.: US 2025/0055882 A1
(43) Pub. Date: Feb. 13, 2025

(54) A METHOD FOR MONITORING OR VALIDATING COMPLIANCE OF A DEVICE ON A NETWORK

(71) Applicant: BRITISH TELECOMMUNICATIONS PUBLIC LIMITED COMPANY, LONDON (GB)

(72) Inventors: Jonathan ROSCOE, London (GB); Fadi EL-MOUSSA, London (GB)

(21) Appl. No.: 18/720,039

(22) PCT Filed: Nov. 23, 2022
(86) PCT No.: PCT/EP2022/083012

§ 371 Date: Jun. 14, 2024

(30) Foreign Application Priority Data
Dec. 22, 2021 (GB) 2118770.3

(51) Int. Cl. H04L 9/40

(52) U.S. Cl. CPC H04L 63/20

(57) ABSTRACT

A method for monitoring or validating device compliance of the attributes of a device on a network, the method including providing a first tree data structure including compliance data associated with a network; performing a comparison of the first tree data structure with a second tree data structure comprising attribute data associated with an electronic device to compare the compliance data with the attribute data; and determining, based on the comparison, whether the electronic device is compliant with the network.

### PRIORITY CLAIM

The present application is a National Phase entry of PCT Application No. PCT/EP2022/083012, filed Nov. 23, 2022, which claims priority from GB Application No. 2118770.3, filed Dec. 22, 2021, each of which hereby fully incorporated herein by reference.

### TECHNICAL FIELD

The present disclosure relates to a method for monitoring or validating compliance of a device on a network, and in particular compliance of attributes of a device on a network. The present disclosure also relates to a computer system for monitoring or validating compliance of attributes of a device on a network.

### BACKGROUND

The proliferation of Internet of Things (IoT) devices in recent years has led to countless vendors offering a variety of devices for scenarios such as environmental control, health monitoring, surveillance, multimedia, interaction, logistics and more.

Due to the computational and power constraints of such devices, security (which relies on cryptographic methods known for their high computational cost) is often a secondary concern. Thus, network owners who allow such devices onto their network expose themselves to new risks.

This is exacerbated when the transient nature of IoT devices is considered, and network operators may wish to allow access to their network to facilitate the operations of suppliers and customers. Devices may cross many networks and networks may contain devices for a variety of vendors.

Similar issues have been seen elsewhere, such as email, where many organizations must cooperate to maintain secure infrastructure when propagating messages between themselves. In relation to email, the Domain-based Message Authentication, Reporting, and Conformance (DMARC), allows organizations to establish policies with regards to mail handling. DMARC allows organizations to publish a security policy that specifies acceptable authentication mechanisms as well as how others should interact with the organization and treat mail routed to/from the organization.

### SUMMARY

The inventors of the embodiments described herein have appreciated the need for a system capable of monitoring or validating whether a device attempting to connect to a network, or that is already in connection with a network, complies with network security policies.

Arrangements of the present disclosure provide a tree data structure having a probabilistic data structure, such as a bloom tree, as a probabilistic data store of device information which can be used to monitor or validate compliance of attributes of a device on a network, such as an entity or organization network.

According to an aspect of the present disclosure, there is provided a method for monitoring or validating device compliance of the attributes of a device on a network, the method comprising: providing a first tree data structure comprising compliance data associated with a network; performing a comparison of the first tree data structure with a second tree data structure comprising attribute data associated with an electronic device to compare the compliance data with the attribute data; and determining, based on the comparison, whether the electronic device is compliant with the network.

In other words, a tree data structure may be used to build a description of attributes of a device such as an electronic device, and a counterpart tree data structure may be used to build a description of attributes, policies, or parameters accepted by a network. The second tree data structure may be considered a descriptor of a device's software and hardware configuration. The tree data structures may be termed compliance trees. The two tree data structures may be conveniently compared to establish if the device described by the second tree data structure will be compliant with policies or security of a network described by the first tree data structure. Network owners such as an organization or entity can use the tree structures as a means of verifying candidate devices before they are permitted within a network.

A device vendor may develop a device with a particular configuration. The device may broadcast its tree data structure on a network it wishes to access. Any relevant party such as a network owner organization, service provider, or network provider may then perform an assessment of that tree data structure to determine whether or not the device wishing to access the network has attributes complying with the relevant security standards or policies of the network.

The attribute data associated with the electronic device comprises one or more hardware and/or software attributes. Each node of the second tree data structure may represent an attribute of the electronic device. The compliance data associated with the network comprises one or more hardware and/or software attributes. Each node of the first tree data structure may represent an attribute accepted by the network. The attributes may include, for example: device type, operating system, operating system version, kernel information, firewall policy, network connectivity, and applications.

The first and second tree data structures may be first and second Merkle trees respectively. Each of the first and second Merkle trees may comprise a plurality of nodes, and each node of the plurality of nodes may have an associated hash generated based on the nodes beneath it. A Merkle tree is a binary tree in which all leaf nodes are associated with a cryptographic hash, and all non-leaf nodes are associated with a cryptographic hash that is formed from the hashes of its child nodes. Each hash in a Merkle tree is different. The hashes may be used to evaluate or compare particular attributes associated with the hashes in the first and second tree data structures. To verify the presence of an element or hash in the Merkle tree, a series of hashes may be provided that when hashed with the element hash, recreate the hash of the Merkle root.

Merkle trees may be used as a mechanism for storing device information. This enables fast and efficient evaluation of compliance as well as the ability to search for devices and related data on a network, which provides an efficient mechanism for managing networks having a plurality of devices such as an Internet of Things (IoT) sensor network.

The performing the comparison may comprise comparing the hashes in the second Merkle tree with the hashes in the first Merkle tree to determine if the hashes in the second Merkle tree are present in the first Merkle tree. In some embodiments, if it is determined that a hash is present in the second Merkle tree that is not present in the first Merkle tree, the method may further comprise determining the electronic device as being non-compliant with the network. This may apply to a full tree data structure, or a fragment or sub portion of a tree data structure. For example, a tree data structure may describe both software and hardware attributes, but only one of the software or hardware fragments or branches may be found to be non-compliant. The presence of a hash in the second Merkle tree of the device's compliance tree denotes or indicates the presence of an attribute of the device that is not accepted by the network, for example because it is an attribute not in line with security policy of the entity or organization. For example, the electronic device may be running a particular kernel version that is not accepted by the network due to its susceptibility to malware.

An evaluation mechanism may be used in combination with the Merkle tree to evaluate compliance between a device and a network which may be particularly advantageous in a multi-component system. The evaluation mechanism may be any suitable evaluation mechanism capable of evaluating the presence or absence of one or more hashes associated with the plurality of nodes. In other words, the evaluation mechanism may be used as a mechanism for assessing compliance of attributes of a device on a network by comparing tree fragments which may be fragments or portions of the tree data structures. The evaluation mechanism may determine that the second tree data structure comprises a hash not present in the first tree data structure. If this is determined, in some embodiments, the method may further comprise determining the electronic device as being non-compliant with the network.

The evaluation mechanism may include, for example, bloom filters, aggregated hashes, or tree structures. Implementation of tree structures may include use of graph theoretic algorithms, for example, to check for equality between fragments of a graph. This may include determining whether one graph (the compliance tree of the device) is a subset or fragment of another graph (the network tree).

Bloom filters may be described as probabilistic data structures and are particularly space-efficient probabilistic data structures. Bloom filters essentially summarize data in a set, and can verify if an element is not in a set. Bloom filters can answer the question “is element x in set S?” with either “maybe” or “definitely not”. In blockchain applications they have traditionally been used in the underlying peer-to-peer network in order to connect to peers who may be in possession of desired data (i.e. blocks for synchronization). Generally, bloom filters help reduce a large search space quickly by verifying the absence of a data point in a set.

The first and second tree data structures may each comprise one or more probabilistic data structures for evaluating the presence or absence of one or more hashes associated with the plurality of nodes, and the method may further comprise using the probabilistic data structures to evaluate the presence or absence of one or more hashes.

A bloom filter is a bit vector built from a group of cryptographic hashes of a data set. A bloom tree uses the same concept, but each node of the tree data structure comprises a bloom filter for the nodes below it in the tree data structure.

Specifically, a bloom tree is a probabilistic data structure that combines the idea of bloom filters with Merkle trees. Where the first and second data trees comprise probabilistic data structures in the form of bloom filters, the first and second data trees may be bloom trees. The first and second tree data structures may comprise a plurality of probabilistic data structures, for example a plurality of bloom filters. Each node of the tree data structure may comprise a bloom filter for the nodes below it.

The nodes of the first tree data structure may represent all possible attributes of the compliance data accepted by the network. The probabilistic data structures may be used to evaluate all possible accepted attributes by evaluating all possible accepted hashes of the tree data structure. The probabilistic data structure, which may comprise a bloom filter, may be considered a list of the attributes compliant with the network.

A tree data structure may refer to a full data structure or a fragment or sub portion of a full data structure. Similarly, the comparison of tree data structures may refer to a comparison of full tree data structures, fragments of full data structures, or any combination of the two. It may be determined that a tree data structure is not compliant. It may also be determined that multiple fragments or sub portions of trees are not compliant. One or more fragments of full tree data structures may be compared with one or more fragments of tree data structures. A fragment may comprise software attributes and another fragment may comprise hardware attributes.

In some embodiments, the method may further comprise updating the first and/or second tree data structures to provide updated compliance and/or attribute data, respectively, and performing a further comparison of the first tree data structure with the second tree data structure. Changes may be made to one or both of the first and second tree data structures. For example, an update in security policy may prompt an update in the first tree data structure. Alternatively or in addition, a change to a device attribute (such as an operating system update) may prompt an update to the second tree data structure. If an update to one or both of the trees occurs, a further comparison may be made to validate compliance of a device with the network. For example, a device previously validated and granted access to the network may be re-evaluated to ensure it continues to comply with network policy. Nodes having associated hashes may be added or removed as appropriate from one or both of the first or second tree data structures.

In some embodiments, the second tree data structure is provided by the associated electronic device. That is, the second tree data structure, or the compliance tree, is self-reported by the electronic device. The manufacturer of the device may provide usage description files and an associated device may announce its descriptor including attributes and capabilities to relevant parties when attempting to access a network.

Tree data structures are built for devices typically based on their attributes, and manufacturers may be typically expected to expose the trees (or hashes of the parent node of the tree data structure describing a device). However, in some embodiments this may not be possible. It may therefore be possible and indeed advantageous to build a tree data structure for a device when the tree data structure or hash of the parent node is not provided, or in other words, a device lacks transparency regarding its attributes. Such a device may be a “black box” system which may be associated with a third-party where other mechanisms to build the tree data structure are not possible.

Therefore, in some embodiments, the method may further comprise interrogating the electronic device to determine the attribute data, and forming the second tree data structure based on the determined attribute data. The interrogating may comprise using signature analysis to construct a tree data structure. Signature detection can be used to identify specific software components. The interrogation may non-exhaustively comprise one or more of: a HTTP query, SSH query, a port scan, network port mapping, or a ping test. The results of the interrogation can then be used to build the tree data structure based on the attributes of the device determined by the interrogation. A comparison may then be made with the network's tree data structure in the manner described above to monitor or validate compliance with the network.

Bloom trees allow for quick and easy comparison of prospective devices. This allows an enterprise to compare its own compliance trees with potential candidates. In some embodiments, information about devices and/or networks such as attribute data and/or compliance data may be shared, for example, on the blockchain ecosystem. In this way, up to date device and network information may be conveniently published and maintained in a way that is accessible for convenient comparison in order to validate or monitor device compliance on a network.

According to another aspect of the present disclosure, there is provided a computer program for carrying out the method according to embodiments described herein.

According to another aspect of the present disclosure, there is provided a non-transitory computer-readable medium comprising instructions for carrying out the method according to embodiments described herein.

According to another aspect of the present disclosure, there is provided a computer system for monitoring or validating device compliance of attributes of a device on a network, the computer system comprising: an obtaining module configured to obtain a first tree data structure comprising compliance data associated with a network and a second tree data structure comprising attribute data associated with an electronic device; a comparison module configured to compare the first tree data structure with the second tree data structure to compare the compliance data with the attribute data; and a determining module configured to, based on the comparison by the comparison module, determine whether the electronic device is compliant with the network.

It will be appreciated that the obtaining module, comparison module, and determining module may be physically separate modules, or one or more of the modules may be part of the same module. For example, the comparison module and the determining module may be separate modules or may be the same module.

The first and second tree data structures may be first and second Merkle trees respectively. Each of the first and second Merkle trees may comprise a plurality of nodes, each node of the plurality of nodes having an associated hash generated based on the nodes beneath it.

The comparison module may be further configured to compare the hashes in the second Merkle tree with the hashes in the first Merkle tree to determine if the hashes in the second Merkle tree are present in the first Merkle tree.

The determining module may be further configured to: if it is determined that a hash in the second Merkle tree is not present in the first Merkle tree, determine the electronic device as being non-compliant with the network.

The first and second tree data structures may each comprise a probabilistic data structure for evaluating the presence or absence of one or more hashes associated with the plurality of nodes; and the comparison module may be configured to use the probabilistic data structure to evaluate the presence or absence of one or more hashes. Each of the first and second tree data structures may comprise one or more probabilistic data structures. The probabilistic data structures may comprise a bloom filter. Each node of the tree data structures may comprise a bloom filter.

The attribute data associated with the electronic device may comprise one or more hardware and/or software attributes, each node of the second tree data structure representing an attribute of the electronic device. The compliance data associated with the network may comprise one or more hardware and/or software attributes, each node of the first tree data structure representing an attribute accepted by the network.

The nodes of the first tree data structure may represent all possible attributes of the compliance data accepted by the network.

The obtaining module may be further configured to obtain updates to the first and/or second tree data structures; and the comparison module may be further configured to perform a further comparison of the first tree data structure and the second tree data structure.

The electronic device may be configured to provide the second tree data structure to the obtaining module.

The obtaining module may be configured to: interrogate the electronic device to determine the attribute data; and form the second tree data structure based on the determined attribute data.

Arrangements of the present disclosure may non-exhaustively provide one or more of: publishing of compliance trees or compliance models to assist vendors developing products for an entity or organization; enforcement of compliance with security policies related to a network; detecting devices that fall out of compliance; detecting malware infected devices; the ability to efficiently verify what aspects of a device violate a policy of a network; the ability to securely publish rules and requirements that vendors can evaluate against without exposing confidential details; and the ability to check changes in the behavior of a device (for example, if it is malware infected). The use of tree data structures as descriptors allows the attributes including capabilities and features of a device to be summarized conveniently, and the use of a mechanism such as a bloom filter allows efficient evaluation of such attributes.

### BRIEF DESCRIPTION OF THE DRAWINGS

The disclosure will be described in more detail, by way of example, with reference to the accompanying drawings, in which:

FIG. 1 is a schematic diagram of a tree data structure according to an aspect of the present disclosure.

FIG. 2 is a schematic diagram of a tree data structure with an electronic device according to an aspect of the present disclosure.

FIG. 3 is a schematic diagram of a fragment of a first tree data structure, a second tree data structure, and corresponding bloom filter representations according to an aspect of the present disclosure.

FIG. 4 is a schematic diagram of second tree data structure and corresponding bloom filter representation according to an aspect of the present disclosure.

FIG. 5 is a schematic diagram of bloom filter representations of a first tree data structure, a second tree data structure of a compliant electronic device, and a second tree data structure of a non-compliant electronic device according to an aspect of the present disclosure.

FIG. 6 is a block diagram of an interrogation process of an electronic device in order to build a tree data structure according to an aspect of the present disclosure.

### DETAILED DESCRIPTION

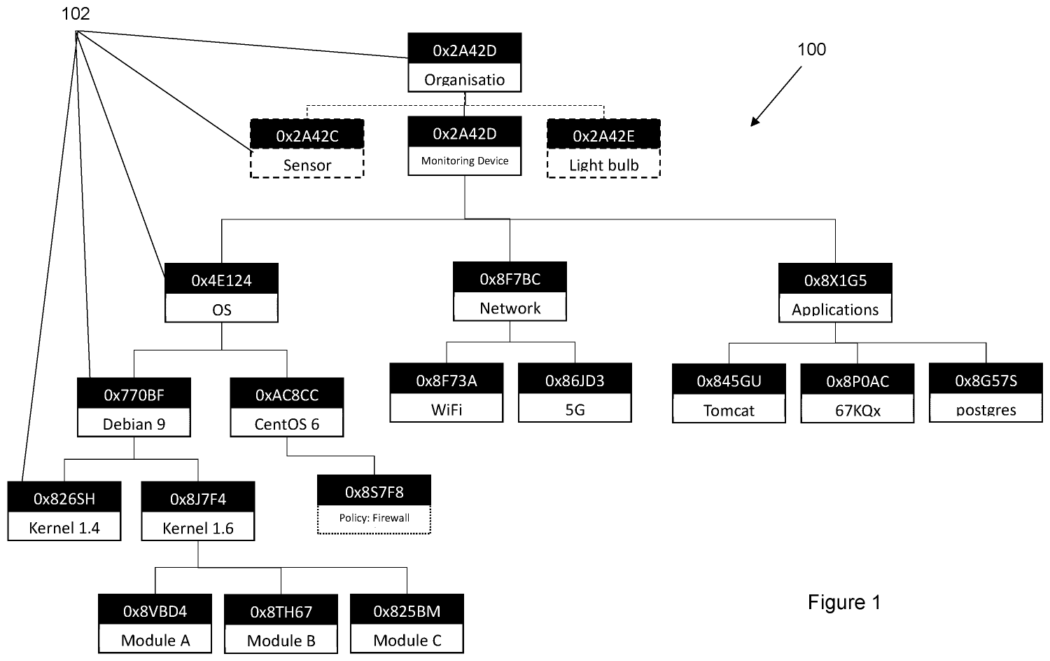

An example method and corresponding computer system for monitoring or validating compliance of attributes of an electronic device on a network will now be described with reference to FIGS. 1 to 6. Like features are denoted by like reference numerals.

FIG. 1 illustrates a first tree data structure 100. The first tree data structure 100 comprises compliance data associated with a network, which in this example belongs to, or is associated with, an organization.

In this example, the first tree data structure is a Merkle tree comprising a plurality of nodes 102. For clarity of the Figure, not every node is denoted by reference numeral 102. Each node of the plurality of nodes 102 has an associated cryptographic hash generated based on the nodes beneath it in the Merkle tree, and each cryptographic hash is different.

The nodes 102 represent the compliance data, which comprises one or more hardware and/or software attributes. Each node of the first data structure 100 represents an attribute that is accepted by the organizations network security policy. In other words, a device having all of, or a subset of, the accepted attributes described by the nodes 102 of the Merkle tree may be considered compliant and therefore be granted access to the organization's network. The nodes 102 represent all possible attributes of the compliance data accepted by the network.

The attributes may include, for example: device type, operating system, operating system version, kernel information, firewall policy, network connectivity, and applications.

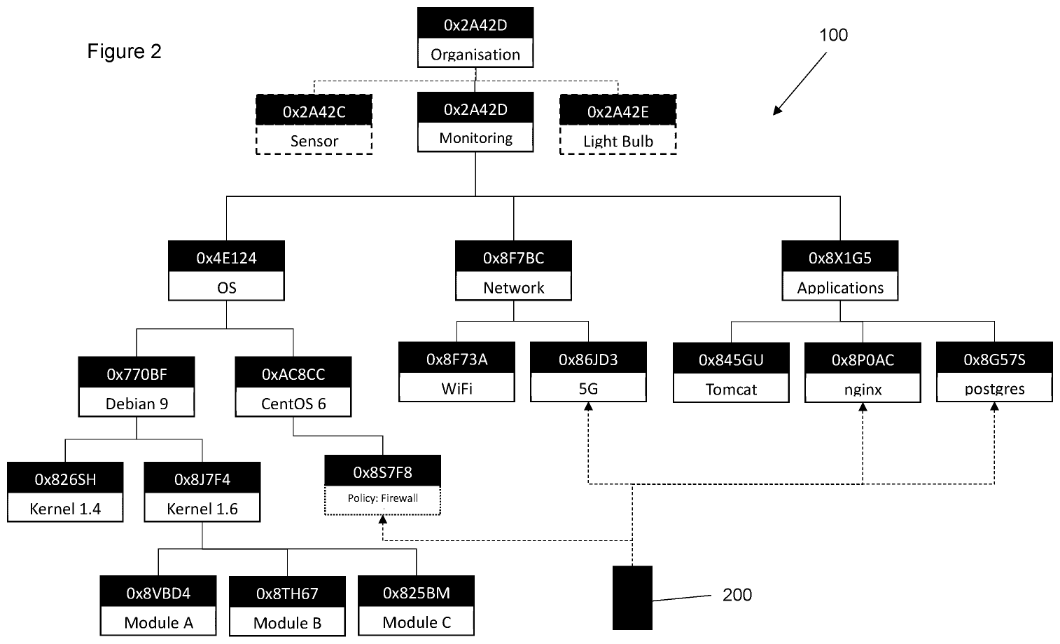

FIG. 2 similarly illustrates the first tree data structure 100 associated with the organization's network, but additionally illustrates an electronic device 200. As will be explained in more detail below with reference to FIGS. 2 to 5, the attributes of the electronic device 200 may be compared with the accepted attributes of the compliance data described in the Merkle tree to determine whether or not the electronic device is compliant with the organization's network.

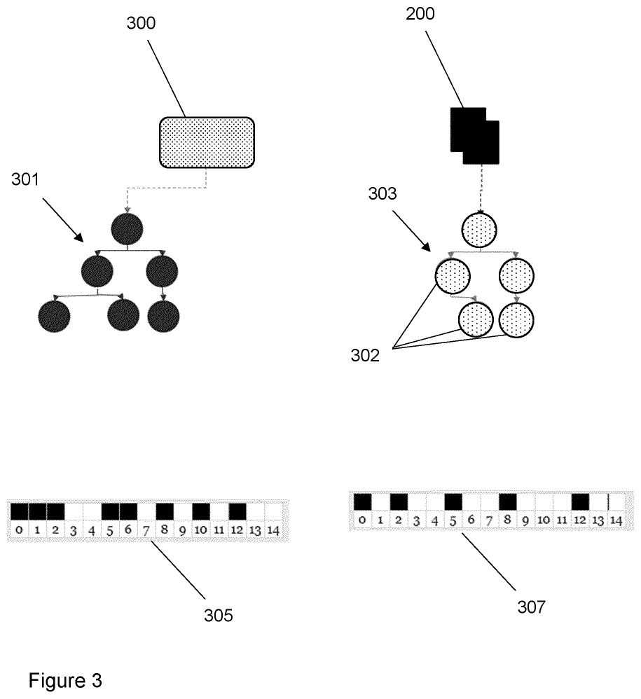

FIG. 3 illustrates a fragment or sub-portion of a first tree data structure 301 associated with the network 300, and a second tree data structure 303 associated with the electronic device 200.

The second tree data structure 303 comprises attribute data associated with an electronic device, and each node 302 of the tree data structure represents an attribute of the electronic device. Again, not all nodes are labelled for clarity.

An obtaining module of a computer system for monitoring or validating device compliance on a network obtains the first and second tree data structures. In this example, the obtaining module has direct access to the first tree data structure 301 as part of the organization's network, and is provided the second tree data structure 303 directly by the electronic device 200.

Significantly, in this example, the first and second tree data structures (of which only a fragment or portion of the first tree data structure is shown) are bloom trees. That is, they comprise a Merkle tree structure but also comprise probabilistic data structures or bloom filters at each node of the tree structure.

A bloom filter 305 corresponding to the root node of the first tree data structure is illustrated, which conveniently summarizes the information or compliance data in the first tree data structure. Similarly, a bloom filter 307 corresponding to the root node of the second tree data structure is illustrated, which conveniently summarizes the information or trait data in the second tree data structure.

Providing the bloom filters allows for a convenient and efficient comparison of attributes associated with the electronic device and the attributes accepted by the organization's network. In this way, efficient validation or monitoring of the compliance or attributes of the electronic device can be provided.

Monitoring or validating compliance of the attributes of the device on the network comprises performing a comparison of the first tree data structure with the second tree data structure in order to compare the compliance data with the attribute data. A comparison module of the computer system performs such a comparison. Performing the comparison comprises the comparing module comparing the hashes in the second Merkle tree with the hashes in the first Merkle tree to determine if the hashes in the second Merkle tree are present in the first Merkle tree. Hence, only the relevant fragment of the first Merkle tree is illustrated and is used in the comparison.

In this example, the comparison of the compliance data and attribute data is made using the probabilistic data structures or bloom filters and particularly the bloom filters for the root nodes of the tree data structures. The bloom filters provide an evaluation mechanism for evaluating the presence or absence of one or more hashes, or one or more attributes. If the comparison determines that a hash or attribute is present in the second tree data structure associated with the electronic device that is not present in the first tree data structure, a determining module of the computer system then determines the device as being non-compliant with the organization's network.

In the embodiment illustrated, the first tree data structure 301 or compliance tree has a number of attributes considered to be accepted by the network, denoted in the illustrated bloom filter 305 in this example as bit vectors 0, 1, 2, 5, 6, 8, 10, and 12. The second tree data structure 303 describes a number of attributes associated with the electronic device, denoted in the illustrated bloom filter 307 in this example as bit vectors 0, 2, 5, 8, and 12.

In this example, as all of the attributes associated with the electronic device are present in the compliance tree of the organization's network, the electronic device is considered to be compliant, or have compliant attributes, with the organization's network and may be granted access. In this example, it does not matter that the compliance tree of the organization's network has additional accepted attributes; the electronic device does not need to comprise all accepted attributes.

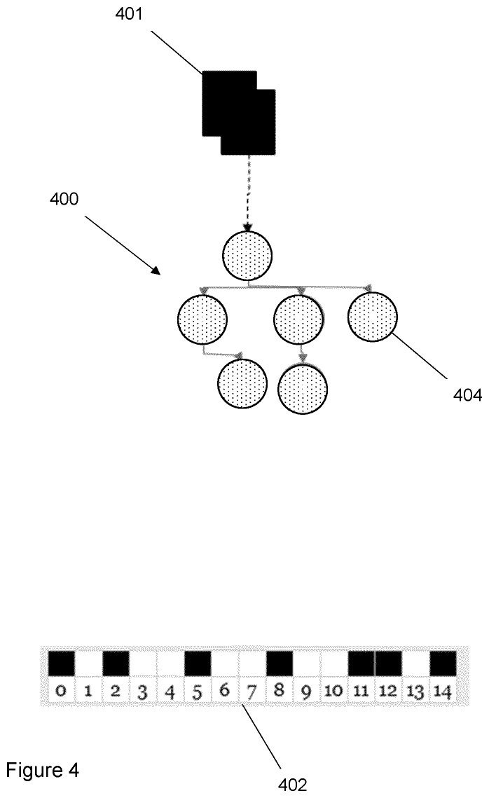

However, FIG. 4 illustrates a second tree data structure 400 associated with a different electronic device 401, together with a corresponding bloom filter representation 402 for the root node of the second tree data structure 400. In this example, the electronic device 401 has associated attributes denoted by bit vectors 0, 2, 5, 8, 11, 12, and 14 in the bloom filter.

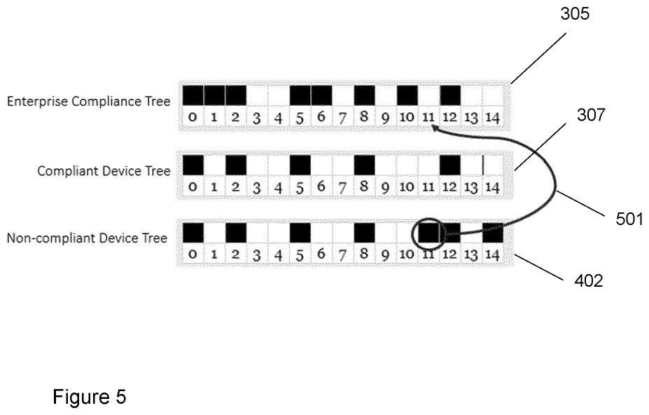

FIG. 5 illustrates a comparison between the bloom filter 305 of the first tree data structure 301 with both the bloom filter 307 of the second tree data structure 303 of the electronic device 200 and the bloom filter 402 of the second tree data structure 400 of the electronic device 401.

As established with reference to FIG. 3 above, the comparison with bloom filter 307 of the electronic device 200 results in a determination that the electronic device 200 is compliant with the organization's network.

However, significantly, second tree data structure 400 comprises a node 404 representing an attribute of the electronic device 401. In the bloom filter 402, this node is represented by bit vector 11 and is highlighted by comparison arrow 501. The first tree data structure 301 does not include the feature associated with node 404, which is denoted by the bloom filter 305 as the bit vector 11 does not appear in the bloom filter 305. Thus, the comparison results in a determination that the electronic device 401 must have an attribute not accepted by the organization's network, or is not compliant with the organization's network. This additional node not present in the compliance tree for the organization's network results in a hash that is not a subset of the compliance tree. The electronic device 401 is thus not granted access to the network.

The compliance tree of first tree data structure 301 may be published by an organization, for example on the blockchain ecosystem. Advantageously, the compliance tree does not expose the details of the organization's security policy directly, but allows the validation or monitoring of attributes of a device to determine their compliance with the network.

It will be appreciated that in some embodiments, one or more attributes of the first tree data structure or compliance tree may be designated as essential. That is, for an electronic device to be determined as compliant, the network policy may require that a particular attribute or characteristic of the electronic device is present. This may be, for example, a particular operating system or software version.

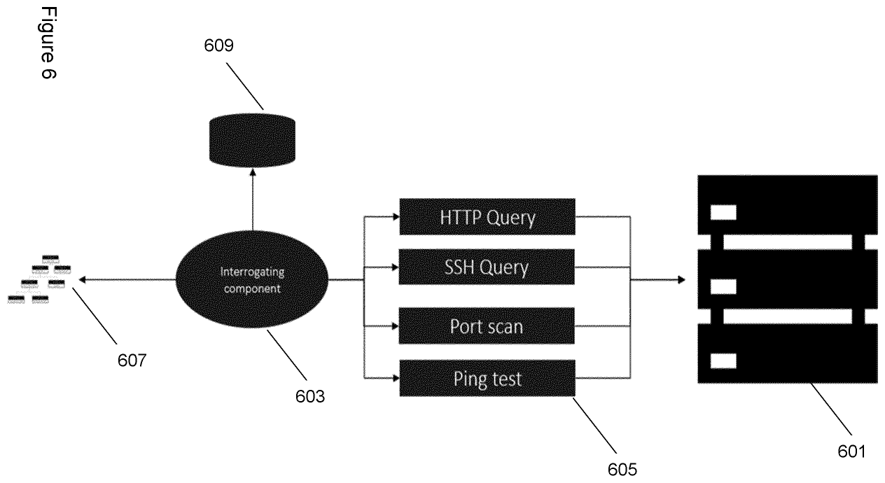

FIG. 6 illustrates the interrogation process of an electronic device 601 that is a “black box”. That is, a tree data structure associated with the electronic device 601 including the device's attribute data is not available to the network for comparison with the compliance tree. In such an example, the network must ascertain attribute data from the electronic device without being directly presented with such data.

An interrogation component 603, which in this example is part of the obtaining module (not shown) of the computer system, is configured to interrogate the electronic device 601. To do so, a plurality of requests 605 are made from the interrogation component 603 to the electronic device 601 in order to ascertain attribute data. These requests may include, for example, a HTTP query, an SSH query, a port scan, or a ping test.

The interrogation component 603 receives responses from the electronic device 601 following the requests 605 and stores the results in a database 609. This allows the computer system, and particularly the interrogation component, to build an understanding of devices which lack transparency with respect to their attribute data. The interrogation of further devices may then be expedited based on the information stored in the database 609 as an electronic device may be recognized corresponding to data stored in the database.

In addition, the received responses from the electronic device 601 are used to build or form a tree data structure 607 comprising attribute data corresponding to the “black box” electronic device 601. A bloom tree structure is formed and may then be used for comparison with a network compliance tree in the manner described above to validate or monitor compliance of attributes of the “black box” electronic device 601 with the organization's network.

Embodiments of the disclosure have been described. It will be appreciated that variations and modifications may be made to the described embodiments within the scope of the present claims.

1. A method for monitoring or validating device compliance of attributes of a device on a network, the method comprising:
providing a first tree data structure comprising compliance data associated with a network;
performing a comparison of the first tree data structure with a second tree data structure comprising attribute data associated with an electronic device to compare the compliance data with the attribute data; and
determining, based on the comparison, whether the electronic device is compliant with the network.

2. The method according to claim 1, wherein the first tree data structure is a first Merkle tree and the second tree data structure is a second Merkle tree, each of the first Merkle tree and the second Merkle tree comprising a plurality of nodes, each node of the plurality of nodes having an associated hash generated based on the nodes beneath that respective node.

3. The method according to claim 2, wherein performing the comparison comprises comparing the hashes in the second Merkle tree with the hashes in the first Merkle tree to determine if the hashes in the second Merkle tree are present in the first Merkle tree.

4. The method according to claim 3, further comprising: if it is determined that a hash is present in the second Merkle tree that is not present in the first Merkle tree, determining the electronic device as being non-compliant with the network.

5. The method according to claim 2, wherein the first tree data structure and the second tree data structure each comprise a probabilistic data structure for evaluating a presence or an absence of one or more hashes associated with the plurality of nodes, the method further comprising using the probabilistic data structures to evaluate the presence or the absence of the one or more hashes.

6. The method according to claim 5, wherein the probabilistic data structure comprises a bloom filter.

7. The method according to claim 2, wherein the attribute data associated with the electronic device comprises one or more hardware attributes or attributes, each node of the second tree data structure representing an attribute of the electronic device.

8. The method according to claim 2, wherein the compliance data associated with the network comprises one or more hardware attributes or software attributes, each node of the first tree data structure representing an attribute accepted by the network.

9. The method according to claim 8, wherein the nodes of the first tree data structure represent all possible attributes of the compliance data accepted by the network.

10. The method according to claim 1, further comprising updating at least one of the first tree data structure or the second tree data structure to provide at least one of updated compliance data or updated attribute data, respectively, and performing a further comparison of the first tree data structure with the second tree data structure.

11. The method according to claim 1, wherein the second tree data structure is provided by the associated electronic device.

12. The method according to claim 1, further comprising interrogating the electronic device to determine the attribute data, and forming the second tree data structure based on the determined attribute data.

13. A computer system comprising at least one processor and memory for carrying out the method of claim 1.

14. A non-transitory computer-readable storage medium comprising instructions for carrying out the method of claim 1.

15. A computer system for monitoring or validating compliance of attributes of a device on a network, the computer system comprising:
an obtaining module configured to obtain a first tree data structure comprising compliance data associated with a network and a second tree data structure comprising attribute data associated with an electronic device;
a comparison module configured to compare the first tree data structure with the second tree data structure to compare the compliance data with the attribute data; and
a determining module configured to, based on the comparison by the comparison module, determine whether the electronic device is compliant with the network.
